(19) United States
(12) Patent Application Publication
(10) Pub. No.: US 2019/0239660 A1
(43) Pub. Date: Aug. 8, 2019

(54) PRODUCT DISPLAY AND METHOD OF MANUFACTURE

(71) Applicant: Artform International Limited, Loughborough. OT (GB)

(72) Inventors: Nigel Smith, West Bridgford (GB); Phil Smith, Coleorton (GB); Carl Nowacki, Loughborough (GB); Alistair Gordon Burns, Loughborough (GB)

(73) Assignee: Artform International Limited, Loughborough, OT (GB)

(21) Appl. No.: 16/333,306

(22) PCT Filed: Sep. 4, 2017
(86) PCT No.: PCT/GB2017/052717

§ 371 Date: Mar. 14, 2019

(30) Foreign Application Priority Data
Sep. 15, 2016 (GB) 1615669.7

(51) Int. Cl. A47F 11/10; F21V 8/00

(52) U.S. Cl. CPC A47F 11/10; A47F 5/0043; G02B 6/001

(57) ABSTRACT

A product display for illuminating merchandise and/or display material includes a light guide that includes a first end and a further end. The light guide is configured to guide light from the first end towards the further end from a light source located at or near the first end of the product display. The product display also includes one or more surface feature respectively at one or more predetermined position on the surface of the light guide for allowing a portion of light to exit the light guide that position. The one or more surface feature a protrusion, indent, undulation or optical pattern.

The present invention relates to a product display and a method of manufacturing a product display. In particular, but not exclusively, the present invention relates to a product display for use in a retail environment as part of a product display apparatus. The present invention may also be used in other environments, for example household, garage, office, outdoor, catering or hospitality environments.

### BACKGROUND

A variety of types of product display apparatus are known, for use in a retail environment. These include shelving units where products may be supported on shelves and product display racks where products may be hung from hooks. Both shelves and hooks may be considered to be types of product display elements arranged to directly support products. It is known for a product display apparatus to be provided in a modular format such that the relative spacing between product display elements can be adjusted to accommodate different sizes of products. It is also known for a product display apparatus to be provided in a modular format such that the display area provided by the product display apparatus is adjustable.

It is known for a product display apparatus to incorporate illumination in order to make the displayed products more appealing to consumers. WO2006/067396A1 discloses a product display apparatus comprising one or more product trays, including platform members for supporting products, and an upright spur arranged to support product trays. The upright spur may be wall mounted and incorporates an upright line of holes. Each product support tray includes a connector arranged to engage a respective hole. Each product tray further includes at least one LED to illuminate products on the platform member. Power is supplied to the LEDs from a power source connected to the upright spur. The connector of each product support tray includes electrical connectors which are resiliently biased outwards such that as the connector engages a hole the electrical connectors make electrical contact with power tracks which run up and down the length of the upright spur.

WO2016/020701A2 discloses a product display system having a shelf unit in the form of a product tray. The shelf unit includes a back shelf portion and a front shelf portion. Together, the back shelf portion and front shelf portion form a shelf for supporting products to be displayed. The front shelf portion includes a connecting element for releasably attaching the front shelf portion to the back shelf portion. An LED light strip is located in the front shelf portion to illuminate the front of the shelf.

With the system described in WO2016/020701A2, LEDs are used to provide light in the directions and positions desired.

LEDs and associated circuit board components may also generate heat, which may be undesirable for some displayed products.

In certain display systems the LED light strip may be undesirable, as often each and every LED may be visible, causing “spotting” of light on the illuminating display.

In addition, cleaning of the display system can be difficult, as liquid cleaning products can cause damage to the LEDs.

### BRIEF SUMMARY OF THE DISCLOSURE

In accordance with a first aspect of the present invention there is provided a product display for illuminating merchandise and/or display material comprising:

a light guide comprising a first end and a further end, the light guide configured to guide light from the first end towards the further end from a light source located at or near the first end of the product display; and

one or more surface feature respectively at one or more predetermined position on the surface of the light guide for allowing a portion of light to exit the light guide at that position,

wherein the one or more surface feature is a protrusion, indent, undulation or optical pattern.

In accordance with a second aspect of the invention there is provided a product display for illuminating merchandise and/or display material comprising:

a light guide comprising a first end and a further end, the light guide configured to guide light from the first end towards the further end from a light source located at or near the first end of the product display; and

at least two surface features at respective predetermined positions on a surface of the light guide for allowing a portion of light to exit the light guide at each respective position, wherein the at least two surface features are one or more of a protrusion, indent, undulation or optical pattern,

the light guide being configured to be connectable in use to a display panel, wherein one of the at least two surface features is positioned on the surface of the light guide to allow a portion of light to exit the light guide and illuminate the display panel.

In accordance with a third aspect of the invention there is provided a product display for illuminating merchandise and/or display material comprising:

a light guide comprising a first end and a further end, the light guide configured to guide light from the first end towards the further end from a light source located at or near the first end of the product display;

at least two surface features at respective predetermined positions on the surface of the light guide for allowing a portion of light to exit the light guide at each respective position, wherein the at least two surface features are one or more of a protrusion, indent, undulation or optical pattern; and

a front shelf portion comprising a body portion and a display panel connectable to the body portion,

wherein a portion of the light guide extending between the body portion and the display panel includes one of the at least two surface features to allow a portion of light to exit the light guide and illuminate the display panel.

In accordance with a fourth aspect of the present invention there is provided a product display apparatus comprising:

a product display as described hereinabove; and

at least two slotted channels; and

at least two shelf brackets configured to support the product display and engage with slots in the slotted channels.

In accordance with a fifth aspect of the present invention there is provided a method of manufacturing a product display, comprising:

providing a light guide comprising a first end and a further end, the light guide configured to guide light from the first end towards the further end from a light source located at or near the first end of the product display, and

a one or more surface feature at a predetermined position on the surface of the light guide for allowing a portion of light to exit the light guide at that position,

wherein the one or more surface feature is a protrusion, indent, undulation or optical pattern.

Certain embodiments of the present invention provide the advantage that a product display is provided that does not need any electrical components. Rather, the light source can be separate from the product display, reducing the need for electrical connections within the display itself.

Certain embodiments provide the advantage that a light guide may be configured with surface feature(s) in predetermined position(s)/location(s) to allow light to exit and illuminate outwards in predetermined direction(s), for example towards a product being displayed.

Certain embodiments provide the advantage of a more uniform illumination of products on the product display and/or the product display itself, compared to known displays.

Certain embodiments provide the advantage that the display is less likely to be subject to heat from the illumination source.

Certain embodiments provide the advantage that light can be transferred to multiple locations from a single source.

Certain embodiments provide the advantage that power consumption may be reduced compared to known systems.

It will be appreciated that the invention is applicable both to embodiments employing the use of a single display panel and to embodiments employing the use of multiple display panels.

### BRIEF DESCRIPTION OF THE DRAWINGS

Embodiments of the invention are further described hereinafter with reference to the accompanying drawings, in which:

FIG. 1 shows an example of a product display apparatus;

FIG. 2 shows the product display apparatus of FIG. 1 with display material loaded thereon;

FIG. 3 shows a cut away view of the product display of FIG. 1;

FIG. 4 shows a close up view of area A of the product display of FIG. 3;

FIG. 5 is an exploded view of an example of a product display apparatus;

FIG. 6 shows an example of a light guide;

FIG. 7 is a diagram illustrating total internal reflection of light;

FIG. 8 shows a perspective view of another product display apparatus with products loaded thereon;

FIG. 9 shows a side elevation view of the product display apparatus of FIG. 8;

FIG. 10a shows another light guide;

FIG. 10b shows yet another light guide;

FIG. 11 shows a light guide having a downwardly directed portion;

FIG. 12 shows an example of a product display apparatus;

FIG. 13 shows an example of a product display apparatus;

FIG. 14 shows an example of a product display apparatus;

FIG. 15 shows a light guide having a mirrored portion; and

FIG. 16 shows a further light guide for illuminating a LCD display.

### DETAILED DESCRIPTION

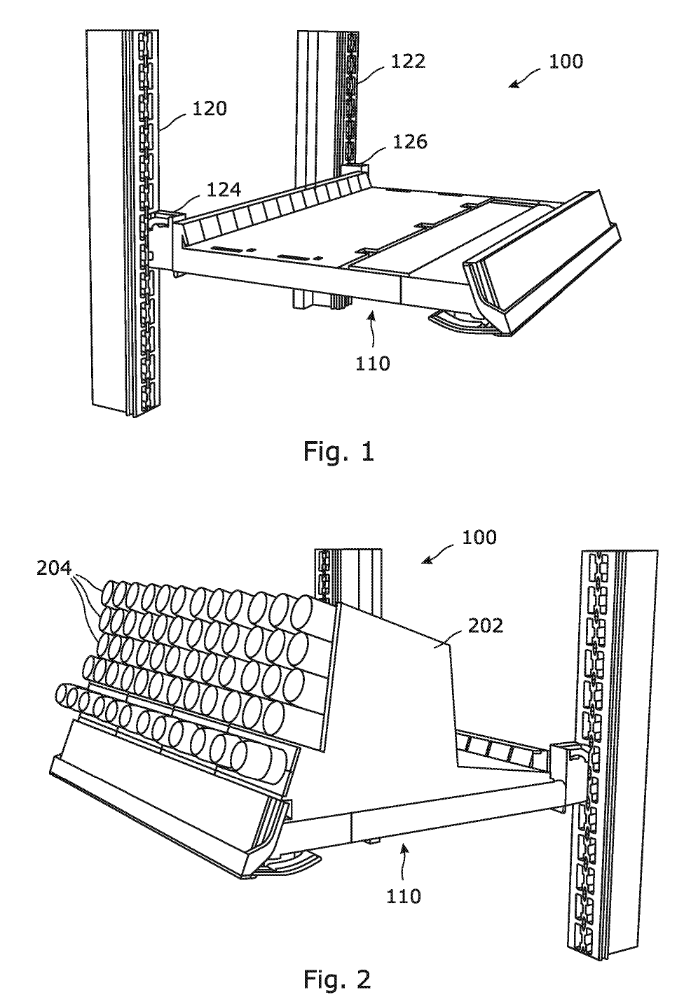

FIG. 1 shows a first embodiment of a product display apparatus 100 including a retail product display 110, in this case a shelf. There are also shown slotted channels 120, 122.

Upright shelf brackets 124, 126 support the retail product display 110 and engage with slots in the slotted channels to support the shelf in a substantially horizontal position in use.

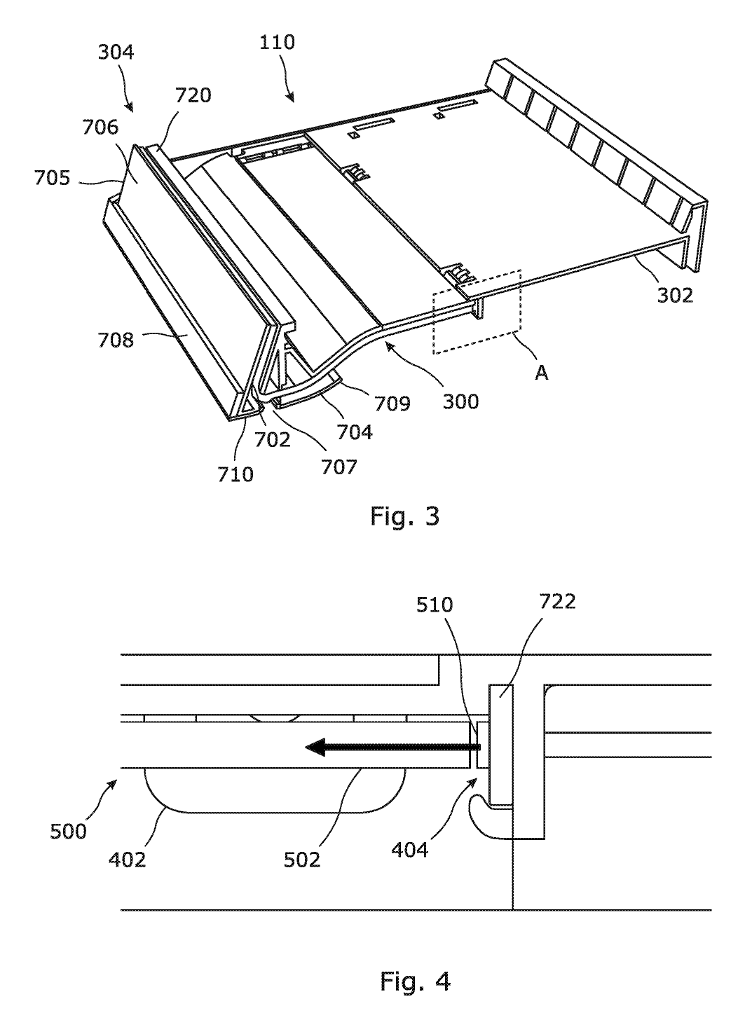

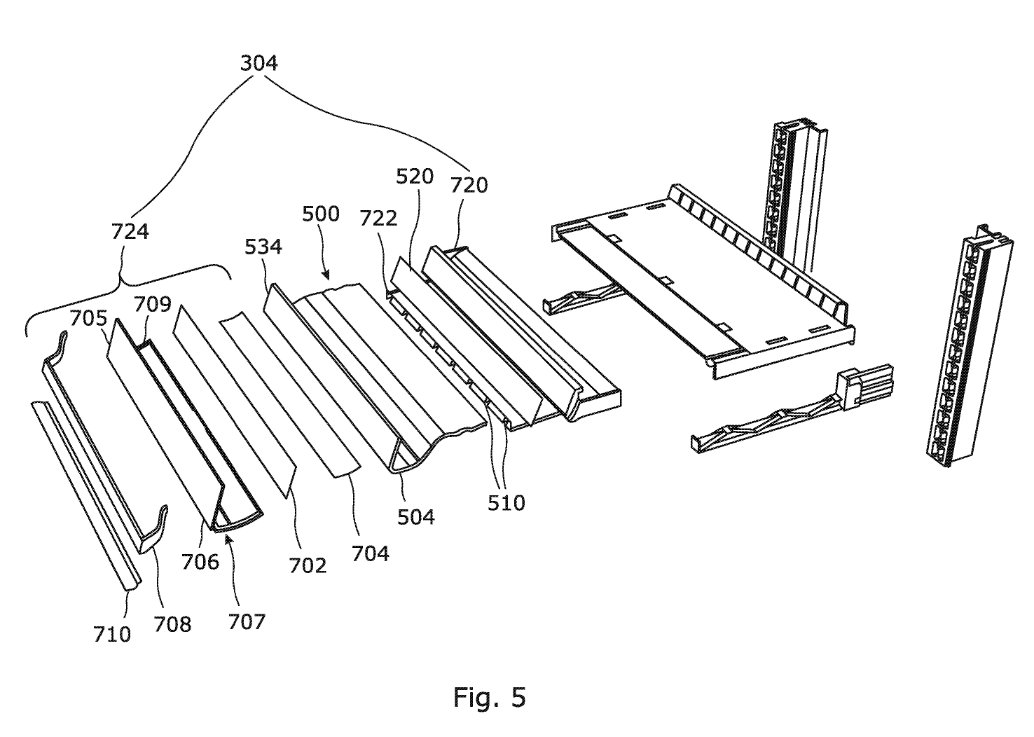

FIG. 2 shows the product display apparatus of FIG. 1 complete with a product tray 202, loaded onto the retail product display 110, with display items 204 loaded thereon. The display items are cosmetics for displaying in a retail shop environment by a retailer. FIGS. 3 and 5 illustrate the retail product display 110 in more detail. In this embodiment, the retail product display includes a shelf platform 302, a light guide 500, a row of LEDs 510 and a front shelf portion 304.

The shelf platform 302 provides an area for the placement and support of at least part of any display material. In this embodiment the shelf platform is made from FR polycarbonate. However the skilled person will be aware that the shelf platform 302 may be constructed from any suitable material, for example wood, glass, metal, other plastic materials, etc. The light guide 500 is releasably attached to an underside of a portion of the shelf platform 302 via releasable attachments, in this example clips 402, which are provided in the shelf platform 302 (best shown in FIG. 4). The clips 402 extend from the rear side of the shelf platform and are received in corresponding voids in the light guide 500 (not shown). The clips form an interference fit with the corresponding voids, such that the shelf platform 302 is securely but releasably attached to the light guide 500.

In this example the plurality of LEDs 510 are provided on a strip 722 (see FIGS. 4 and 5). The strip 722 is housed in a groove 404 in the underside of the shelf platform such that the LED light 510 is positioned at a rear end 502 of the light guide 500 to direct light towards and into the light guide 500 (as illustrated by the arrows in FIG. 4).

As many or as few LEDs as is necessary may be used for a desired amount of emitted light.

FIG. 5 illustrates the retail product display of FIG. 3 in its deconstructed form. The front shelf portion 304 comprises a body portion 720 which is releasably connectable to the front of the shelf platform using clips (not shown).

The front shelf portion 304 further comprises a display panel 724 releasably connectable to the body portion via a lens holder 708. An upwardly directed portion 534 of the light guide 500 extends between the body portion 720 and the display panel.

The display panel 724 includes a front lens 706. In this example the front lens is made from clear plastic, for example polycarbonate and includes a substantially vertical portion 705 and a substantially horizontal portion 709. The display panel 724 also includes a first product label 702, situated between the substantially upwardly directed portion 534 of the light guide 500 and the substantially vertical portion 705 of the front lens 706. The first product label 702, may include product details e.g. brand, product name, price, or a combination thereof.

The display panel 724 also includes a further light guide 710 positioned in proximity to surface feature 504, for guiding light exiting the surface feature.

The further light guide 710 may be configured to guide light and project it in the direction of retail shoppers. This acts to “highlight” or “frame” the retail product display with light, making it more visibly striking to retail shoppers.

In this example the further light guide 710 is a shelf highlighter, situated below the front lens 706 and the lens holder 708. In this example the shelf highlighter 710 is made from a translucent plastic, for example polycarbonate. Aptly the shelf highlighter may be made from a colour tinted translucent plastic.

In this example the display panel 724 also includes a further product label 704, positioned between the light guide 500 and the substantially horizontal portion 705 of the front lens 706. This may contain further product information, which is not so essential as to be in full view, for example a product barcode.

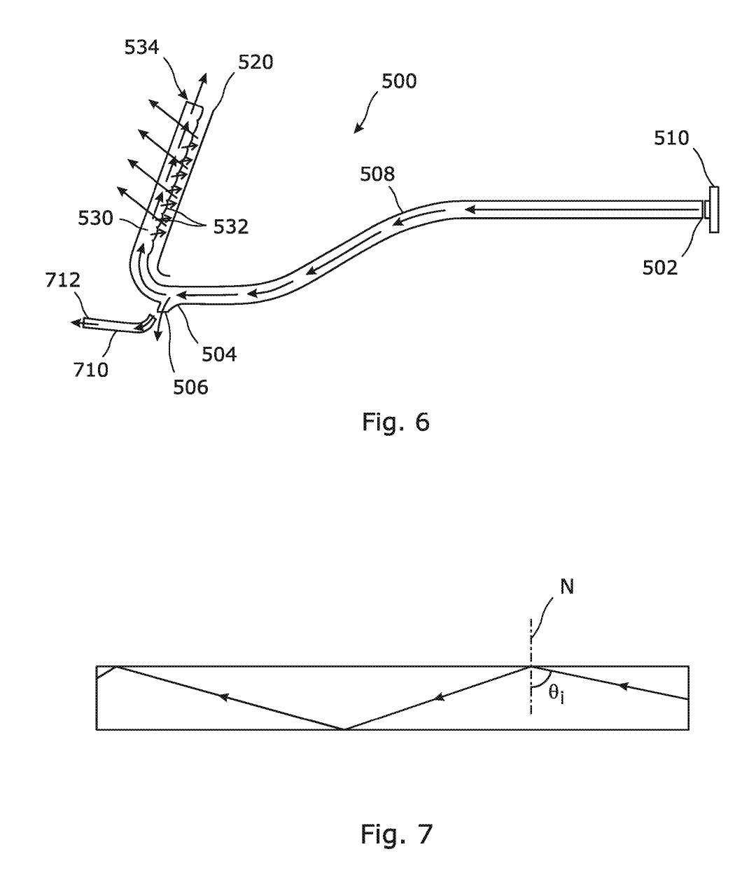

FIG. 6 illustrates a side view of the light guide 500. The light guide 500 is formed from a substantially transparent panel. In this case the substantially transparent panel is formed from an optical grade plastic material, which in this example, is an optical grade polycarbonate material, PMMA acrylic Evonik 8N. Other optical grade materials are Makrolon LED2045 or LED2245 and Apec 1697 or 1797. In use, the light from the LEDs 510 transmits through the light guide 500 (as shown by the arrows). The light is transmitted by internal reflection towards the further end of the light guide when the light is incident on the boundary (or surface) of the light guide at an angle of incidence θ₁ (that is the angle from a normal N drawn perpendicular to the medium surface) greater than the critical angle of the light guide 500 (as shown in FIG. 7).

That is, the light guide is configured for total internal reflection of light incident at an angle above a critical angle, according to the physical laws governing total internal reflection. The critical angle of a medium of a given material is the angle of incidence at which light will no longer refract through the medium. For example, if the angle of incidence at which light meets a surface of the medium is less than the critical angle, the light will refract through the medium. If the angle of incidence is greater than the critical angle, the light will totally internally reflect from the surface of the medium.

Aptly, the light guide is configured for total internal reflection of light incident at an angle of substantially 42 degrees (in other words, the angle 42 degrees is the critical angles of the light guide).

Thus, for a material having a critical angle of 42 degrees, light, incident at an angle of 42 or more up to around 90 degrees, will escape from the light guide. The light guide 500 also includes a surface feature 504, which is a protrusion extending from a surface of the light guide for directing a portion of light out of the light guide 500. The surface feature 504 is shaped so that incident light can be reflected within the surface feature 504 and reaches a tip 506 of the surface feature at an angle of incidence smaller than the critical angle of the light guide 500. In this way, the light can exit the tip 506 of the surface feature.

A portion of light reflected in the light guide will avoid being reflected in the surface feature 504, and will continue reflecting along the internal surfaces of light guide 500.

In this example the surface feature 504 is a protrusion. Aptly the surface feature may be any feature that causes light to exit at that position, i.e. by causing reflection at an angle of incidence smaller than the critical angle of the light guide 500.

In this example, the retail product display has a width of 320 mm, a depth of 250 mm and a height of 50 mm.

In this example the protrusion has a width of substantially 2 mm. In this example the protrusion protrudes from the surface of the light guide by substantially 1.5 mm. In this example the protrusion has a radius of curvature of substantially 3.5 mm away from the general direction of travel of light at that location within the light guide. In a region close to an end of the light guide (opposite to end 502), the light guide curves upwardly such that it has a substantially upward standing portion 534.

The skilled person would understand that the critical angle of the light guide will vary depending on the material from which it is composed. For example, the critical angle of Perspex plastic is around 42 degrees. The critical angle of glass is between substantially 30 and 42 degrees. The critical angle of diamond is substantially 24 degrees. Thus the skilled person would design the protrusion accordingly.

The light guide includes a further surface feature 530 located on a surface of the substantially upwardly directed portion 534. In this example the further surface feature 530 is an optical pattern. The optical pattern is an optically patterned area configured to alter or reduce the angle of incidence of light at the surface such that at least a portion of light can exit the light guide at the optically patterned portion.

The optical pattern is a predetermined pattern of undulations 532 in the surface of the light guide. The undulations 532 operate in the same way as described above with regards to the surface feature 504 in directing light out of the light guide.

Each undulation is shaped so that incident light can be reflected within the undulation 532 and reaches that undulation at an angle of incidence smaller than the critical angle of the light guide 500. In this way, the light can exit the undulation.

Light exiting a respective undulation is directed towards a reflective panel 520, located between the body portion of the front shelf portion and the patterned area of the light guide, for reflecting light towards the display panel. The light reflects off the reflective panel 520, such that the direction of travel is back towards the light guide (as indicated by the arrows in FIG. 6).

Each reflected light portion travels through a side of the transparent panel of the light guide, travels across the light guide and subsequently travels through an opposing side of the transparent panel of the light guide.

The undulations are arranged in rows, whereby each row includes a longitudinally extensive undulation, which extends in a longitudinal direction.

In this embodiment the undulations have radius of curvature of 1.5 mm. In this embodiment the undulations have a depth of 0.25 mm. In this embodiment the centre points of successive undulations are spaced 2.5 mm apart.

When the LEDs 510 are turned on, light is emitted into the light guide 500 and then reflected along the interior of the light guide. A portion of the light exits the protrusion 504. In this case the protrusion is configured such that some of the exiting light is directed into the shelf highlighter 710, i.e. the further light guide.

Once inside the shelf highlighter 710 the light is directed along the shelf highlighter by internal reflection. The light is then directed out of a front end 712 of the shelf highlighter (as indicated by the arrows through the shelf highlighter 710 in FIG. 6).

The remaining light exiting the protrusion is directed substantially downwardly (as indicated by the arrows exiting the end 506 of protrusion 504 in FIG. 6). The light is allowed to pass through a gap 707 in the front lens 706 (as shown in FIG. 3).

Any light exiting the light guide at the optical pattern is subsequently reflected through the light guide and out of an opposing side of the transparent panel of the light guide. This light provides back lighting for the first product label 702, such that the first product label is illuminated through the front lens 706.

That is, the contents of the first product label 702 are illuminated by light exiting the light guide. The first product label will hence be clearly visible to a consumer through the front lens 706.

That is, a surface of the portion of the light guide extending between the body portion and the display panel includes an optically patterned area configured to alter or reduce the angle of incidence of light at the surface such that at least a portion of light can exit the light guide at the patterned portion and illuminate the display panel.

Each LED can illuminate a substantially 2.5×3.1 cm section of the first product label 702. A method of manufacture of a retail product display includes providing a light guide with a first end and a further end. The light guide is configured to guide light from the first end towards the further end from a light source located at or near the first end of the retail product display, and at least one surface feature at a predetermined position on the surface of the light guide for allowing a portion of light to exit the light guide at that position. The at least one surface feature is a protrusion, indent, undulation or optical pattern.

Various modifications to the detailed designs as described above are possible. The product display apparatus may be used to display any items in a retail shop environment, or the like.

Aptly, the light guide 500 may include a transparent, substantially transparent, semi-opaque or tinted panel.

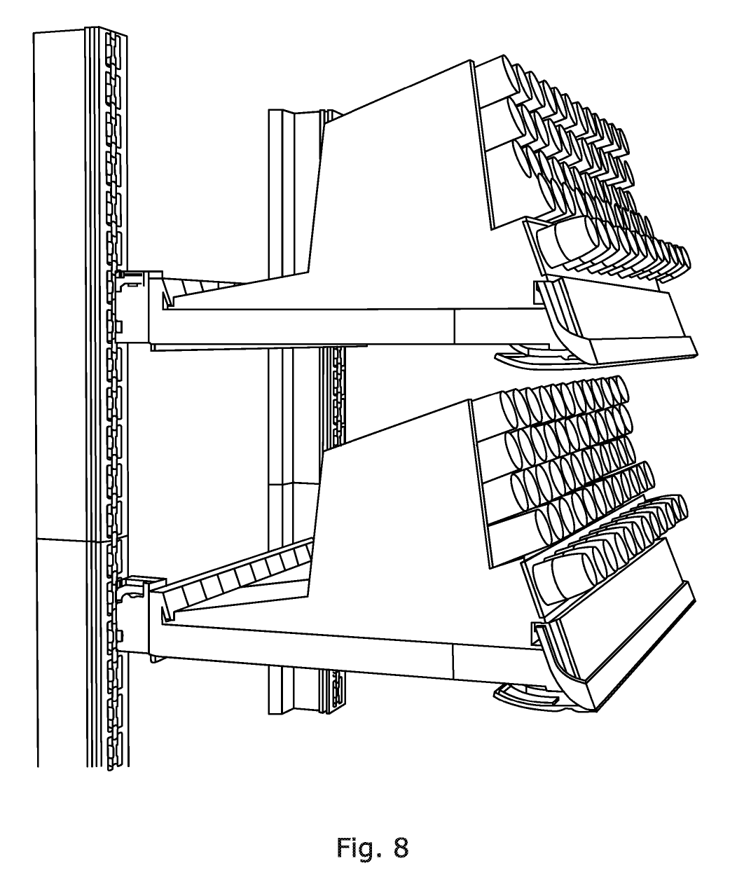

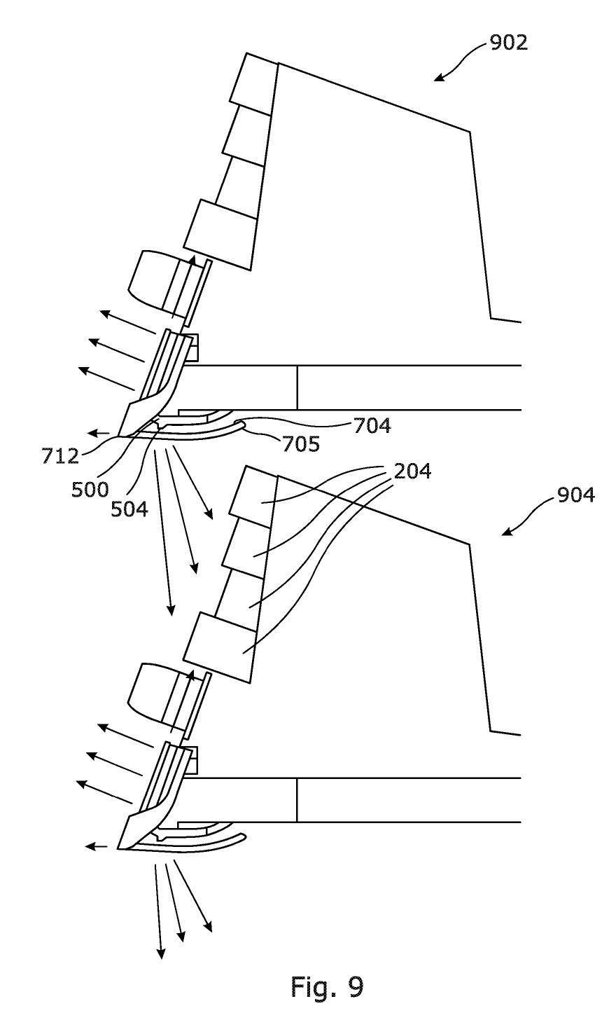

As shown in FIGS. 8 and 9, more than one retail product display may cooperate, whereby the emitted light from a retail product display may be used to produce a down lighting effect, illuminating at least one other retail product display.

FIG. 9, illustrates a first retail product display 902, wherein light is emitted from an optical pattern of the light guide 500, directly from protrusion 504 and from a front end 712 of the shelf highlighter 710. The light emitted directly from the protrusion 504 illuminates the products 204 of a second retail product display 904.

The second retail product display 904 contains corresponding features to that of the first retail product display. Alternatively the second retail product display 904 may contain different features to those of the first retail product display.

Instead of the panel-like shape of light guide described above, any shape may be used for the light guide, e.g. the light guide may curve in any direction. The light guide may be used to provide up-lighting, down-lighting, side-lighting, back-lighting or forward-lighting.

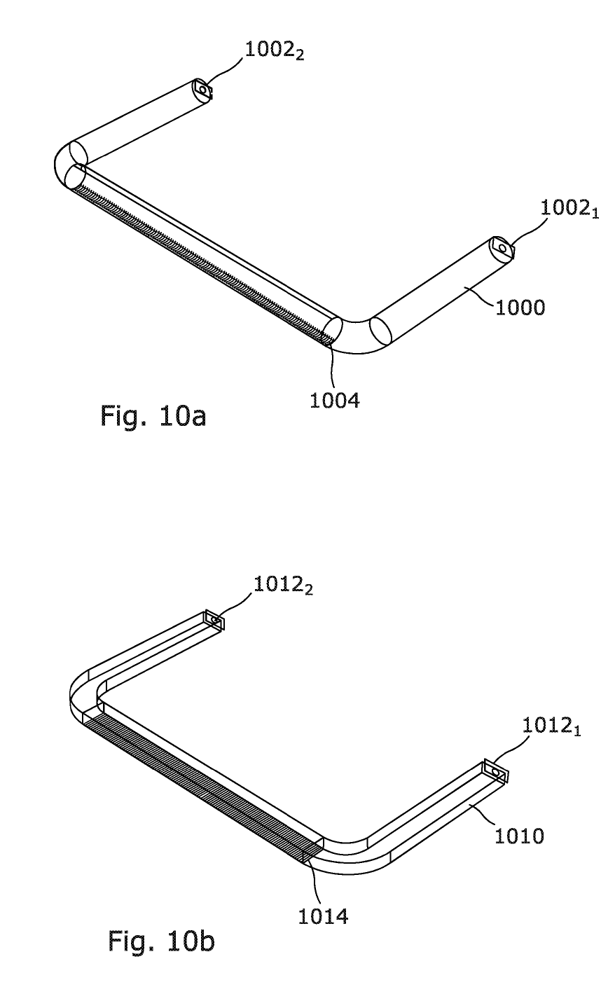

FIG. 10 illustrates a further embodiment, wherein the light guide is a shape of a substantially constant cross sectional area throughout. That is, FIG. 10a illustrates a light guide 1000, which is a tube shape. Light is emitted into opposing ends of the light guide 1000 by two LEDs 1000₁ and 1000₂. Light is reflected around the light guide and, if travelling at an angle greater than the critical angle, will escape the light guide at the optical pattern 1004.

FIG. 10b illustrates a light guide 1010, which is a prism of rectangular cross-section. Light is emitted into opposing ends of the light guide 1010 by two LEDs 1010₁ and 1010₂. Light is reflected around the light guide and, if travelling at an angle greater than the critical angle, will escape the light guide at the optical pattern 1014.

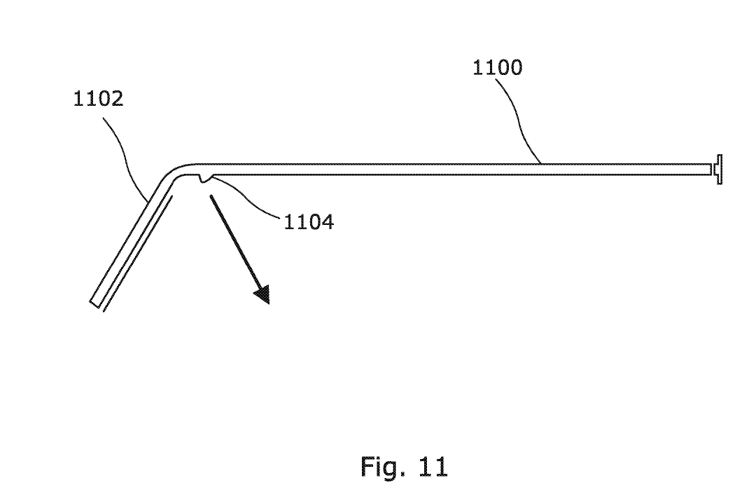

FIG. 11 illustrates a further embodiment, wherein the light guide 1100 curves downwardly such that it has a substantially downwardly directed portion 1102.

In the above described embodiments the shelf panel is a separate component to the light guide. However it may itself be a shelf or other retail display product. That is, the light guide provides the sole means for accommodating display material.

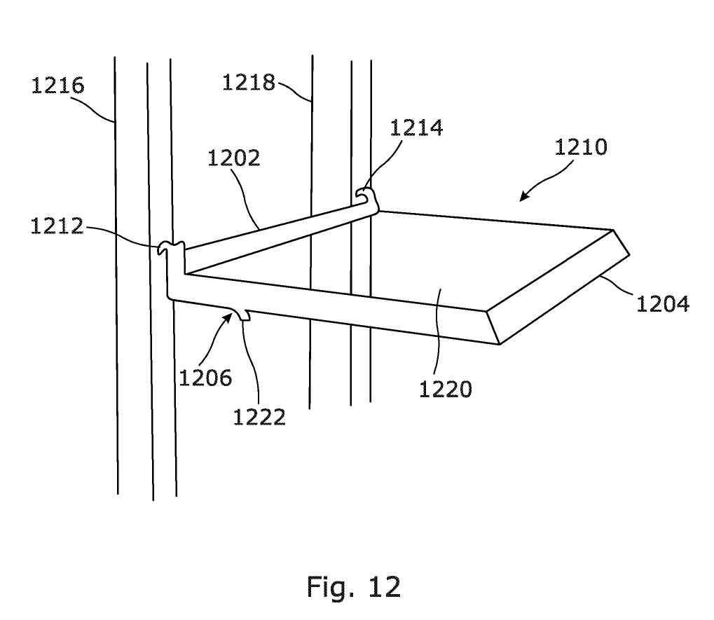

FIG. 12 shows another embodiment of a retail product display 1210, in this case a shelf, for illuminating merchandise and/or display material including a light guide including a first end 1202 (along the rear of the shelf) and a further end 1204 (along the front of the shelf). The light guide is configured to guide light from the first end towards the further end from a light source (not a visible in the drawing) located at or near the first end of the retail product display.

The retail product display 1210 has a surface feature, which in this case is a protrusion 1206 that extends outwards from a lower surface 1208 of the retail product display 1210 and extends across the full width of the retail product display. The position of the surface feature is predetermined at a location on the surface of the light guide for allowing a portion of light to exit the light guide at that position. The surface feature could also be an indent, undulation or optical pattern, more than one, or a combination thereof may be used.

The shelf has hooks 1212, 1214 for engaging with upright shelf brackets 1216, 1218, such that the shelf is in a substantially horizontal position in use. The shelf platform 1220 provides an area for the placement and support of at least part of any display material. Display items may be stacked on the shelf platform 1220 of the shelf e.g. cosmetic items for displaying in a retail shop environment.

In this embodiment the shelf platform is made from a substantially transparent panel. In this case the substantially transparent panel is formed from an optical grade plastic material, which in this example, is an optical grade polycarbonate material, PMMA acrylic Evonik 8N.

In use, the light from LEDs (not shown) transmits through the light guide. The light is transmitted by internal reflection towards the further end of the light guide when the light is incident on the boundary (or surface) of the light guide at an angle of incidence θ₁ greater than the critical angle of the light guide.

The light guide also includes a surface feature 1206, which is a protrusion extending from a surface of the light guide for directing a portion of light out of the light guide. The surface feature 1206 is shaped so that incident light can be reflected within the surface feature and reaches a tip 1222 of the surface feature at an angle of incidence smaller than the critical angle of the light guide. In this way, the light can exit the tip 1222 of the surface feature.

A portion of light reflected in the light guide will avoid being reflected in the surface feature 1206, and will continue reflecting along the internal surfaces of light guide.

In this example the protrusion protrudes from the surface of the light guide by substantially 1.5 mm. In this example the protrusion has a radius of curvature of substantially 3.5 mm away from the general direction of travel of light at that location within the light guide.

FIG. 13 shows another embodiment of a retail product display 1310, including a light guide 1300. In this embodiment the light guide 1300 is supported by in a substantially horizontal position by a shelf support 1306. An end 1308 of the light guide 1300 is inserted into a slot 1302 in the shelf support 1306, as indicated by the arrows.

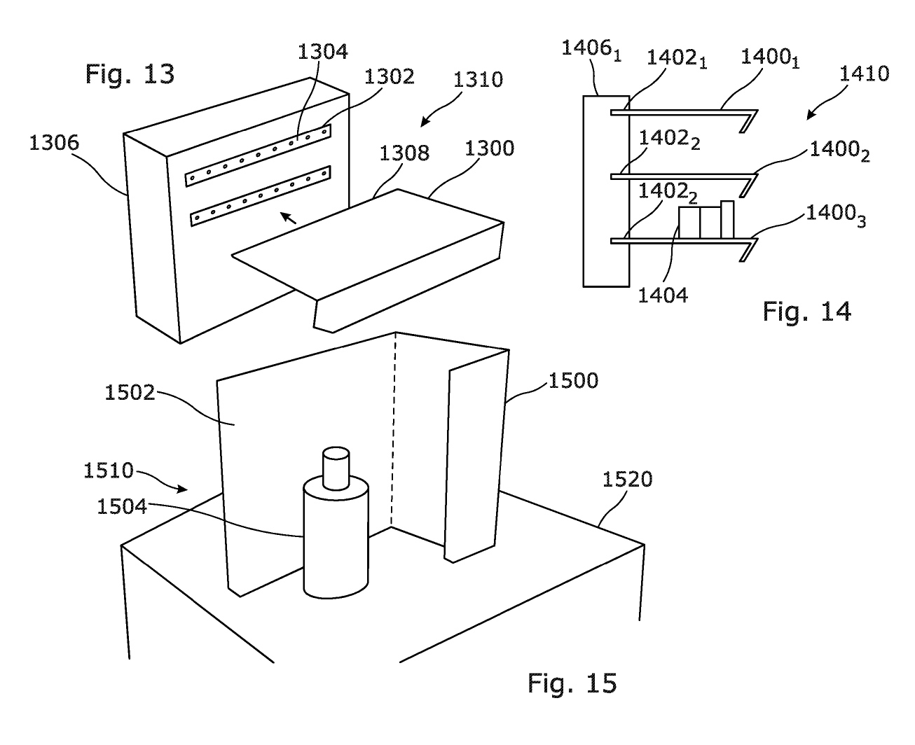

FIG. 14 shows another embodiment of a retail product display 1410, including light guides 1400₁₋₃. The light guides are supported in substantially horizontal positions in shelf support 1406 by slots 1402₁₋₃. Display material 1404 is supported by light guide 1400₃.

FIG. 15 shows another embodiment of a retail product display 1510, including a light guide 1500. In this embodiment the light guide is positioned in a substantially vertical position on platform 1520. Display product 1504 is also located on platform 1520.

The light guide 1500 includes a mirrored portion 1502. The mirrored portion acts to reflect light from the light guide onto display product 1504.

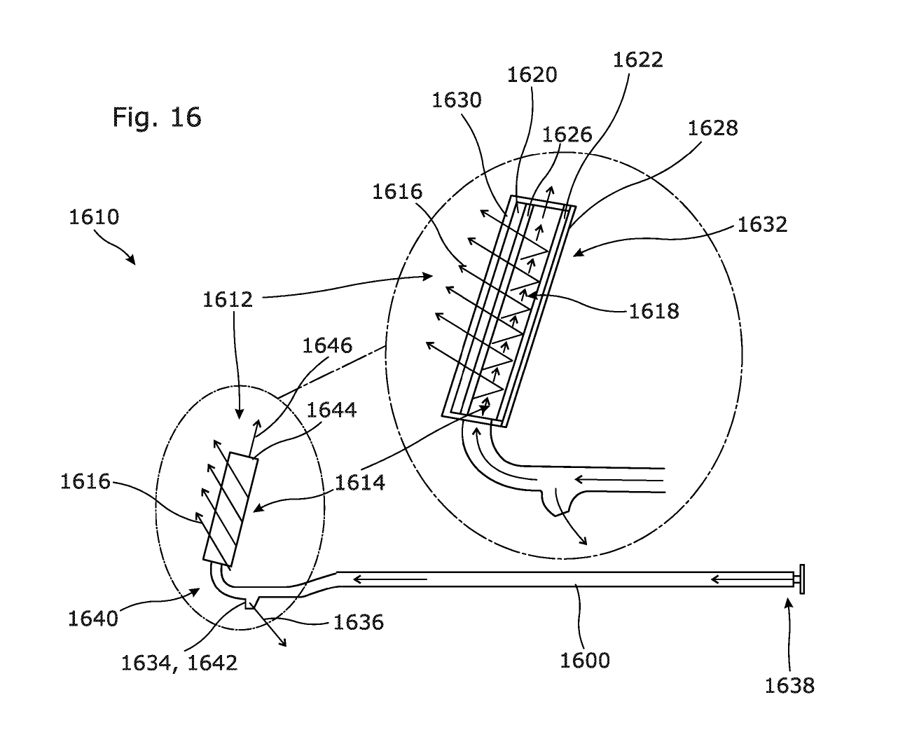

FIG. 16 shows a further embodiment of a retail product display 1610. The retail product display 1610 includes a light guide 1600 and a display panel 1612 connected to the light guide 1600. The light guide 1600 has a first surface feature 1614 that is positioned so as to allow a portion of light 1616 to exit the light guide 1600 and illuminate the display panel 1612.

As shown in the enlarged image of FIG. 16, the first surface feature 1614 is an optical pattern 1618 which is configured to alter or reduce the angle of incidence of light at the surface such that at least a portion of light 1616 can exit the light guide 1600 at the optically patterned portion 1618. The optical pattern 1618 may be a predetermined pattern of undulations (not shown) in the surface of the light guide 1600, as previously described with reference to FIG. 6. The optical pattern 1618 may instead take another form. Further still, the first surface feature 1614 may be a protrusion or indent (or a series of protrusions or indents) which allows illumination of the display panel 1612.

The portion of light 1616 that exits the light guide 1600 provides back lighting for the display panel 1612.

In the example shown in FIG. 16, the display panel 1612 includes a LCD display screen 1620. The LCD display screen 1620 is able to display information, such a pricing, via liquid crystals which are illuminated by the portion of light 1616 that exits the light guide 1600 at the optical pattern 1618. Accordingly, the light board or light source normally provided with a LCD display assembly is not required because the light from the light guide 1600 is being used to illuminate the LCD display screen 1620.

It is envisaged that, in other embodiments of the invention, the LCD display screen may be replaced by another type of electronic or digital display screen.

The display panel 1612 further includes a reflector 1622 to reflect the light along the optical pattern 1618 and out towards the LCD display screen 1620. The display panel 1612 also includes a series of diffusers and prisms 1626. Moreover, the display panel 1612 includes a rear cover 1628 located behind the reflector 1622 and connectable to a front cover 1630. The front cover 1630 and the rear cover 1628 connect to form a LCD display housing 1632 to house the reflector 1622, the LCD display screen 1620 and the diffusors and prisms 1626.

The retail product display 1610 shown in FIG. 16 also includes a second surface feature 1634 which directs a portion of light 1636 to exit the light guide 1600 in a different direction to the first surface feature 1614. In particular, the second surface feature 1634 directs a portion of light 1636 beneath the light guide 1600, e.g. towards a product being displayed on shelf positioned beneath the light guide 1600. In the example shown, the direction of the portion of light 1636 exiting the second surface feature 1634 is downwards and angled backwards towards the first end 1638 of the light guide 1600. The direction may differ, e.g. it may be vertically downwards or downwards and angled frontwards towards the further end 1640 of the light guide 1600.

The second surface feature 1634 is located on an underside of the light guide 1600 between the first end 1638 and the further end 1640 of the light guide 1600. The second surface feature 1634 shown in FIG. 16 is located nearer the further end 1640 than the first end 1638, but this may not be the case.

The second surface feature 1634 is a protrusion 1642 which permits light to exit the light guide 1600 in the manner previously described in relation to FIG. 6.

The retail product display 1610 of FIG. 16 further includes a third surface feature 1644 which directs a portion of light 1646 to exit the light guide 1600 in a different direction to the first and second surface features 1614, 1634. In particular, the third surface feature 1644 directs a portion of light 1646 out of the top of the display panel 1612 which helps illuminate a product located on the retail product display 1610 (i.e. a product positioned on the light guide 1600 when the light guide 1600 is being used as a shelf/platform).

The third surface feature 1644 is a protrusion (not shown) which allows a portion of light to extend through the display panel 1612 and exit through the protrusion.

The light guide 500 described in the first embodiment has two surface features, protrusion 504 and optical pattern 530. There could of course be any number of surface features, depending on the lighting requirements of the product display. This also applies to any of the light guides described hereinabove.

Any of the light guides described hereinabove may include a plurality of surface features, each of which directs a portion of light to exit the light guide in a different direction.

Directions of light may include out a front of the light guide, downwards underneath the light guide and upwards above the light guide. The light may also be angled towards or away from the first end of the light guide.

The surface features may not be located in the position described in the above examples, but may be located in any position at which the release of light is desirable. The skilled person would be aware that these surface features could be of any type as discussed above, or any textured surface which provides the same effect.

Aptly the surface feature 504 may be a protrusion, indent, undulation or optical pattern. Aptly the further surface feature 530 may be a plurality of protrusions, indents or undulations.

The dimensions given in the described example for the surface feature and the further surface feature have been chosen to optimise the exiting of light as desired for the described apparatus. Aptly, the dimensions of the feature and/or the further surface feature may be different for an apparatus of different dimensions, for example. The dimensions of the feature and/or the further surface feature may be different for a light guide of a different material, for example.

The configuration of the optical pattern will be arranged according to the desired light emitted from the optical pattern. The optical pattern of the above described example may include a regular grid of undulations. Alternatively, the optical pattern may include an irregular grid or array of undulations. Alternatively, the optical pattern may include any suitable pattern of undulations, for example a cross, textured, frosted or dimpled formation.

In the above described examples the light guide is constructed from optical grade polycarbonate. However, any suitable optical grade material could be used, for example optical grade acrylic (for example PMMA acrylic Evonik 8N, Acrypet VH or Diakon CLG902) or optical grade glass (for example Crown glass, fused silica, BK7, B270).

Any suitable light source could be used to emit light into the light guide, e.g. LECs, OLEDs, LEECs, etc.

The LED, plurality of LEDs or other light source, may be attached to any suitable part of the retail product display and in any suitable manner such that light is directed into the light guide. There may be any number of LEDs, for example there may be 8 LEDs (as shown in FIG. 7). Alternatively, there may be 12 LEDs.

The overall retail product display, in particular the display depth, may be varied by changing the depth of the shelf platform 302, the light guide 500 or the front shelf portion 304.

The front shelf portion 304, if present, may include different features to those described above. For example, the first and second product labels are optional.

Instead of first and second product labels, the front shelf portion 304 may include a printed graphic, which is illuminated by the optical pattern. That is the printed graphic may be backlit by the optical pattern. Alternatively the front shelf portion 304 may include a touch screen and/or an electroluminescent panel.

Alternatively, the front shelf portion 304 may contain these additional features in addition to those described above.

In the above described embodiments, the critical angle of the light guide is 42 degrees. Thus an angle between around 40 and around 90 degrees would cause light to reflect within the light guide.

Aptly, the critical angle is between around 20 and 90 degrees. More aptly, the critical angle is between 30 and 90 degrees, or between 35 and 90 degrees, or between 20 and 89 degrees, or between 30 and 89 degrees, or between 40 and 89 degrees, or between 20 and 50 degrees.

It will be appreciated that numerous advantages can be achieved with the system and method described; some of those are achieved by the overall system, some are achieved by the optional features.

Aptly, the light guide may guide light to illuminate both a retail product display and a neighbouring retail product display.

Aptly, the shelf highlighter may be configured to illuminate display material of an adjacent retail product display.

Aptly, the incorporation of the light guide into the shelf itself may reduce the number of components required in the retail product display, for example LEDs, as less light is wasted.

The retail product displays described above may instead be product displays that are used in environments other than retail, for example household, garage, office, outdoor, catering or hospitality environments.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A product display for illuminating merchandise and/or display material comprising:
a light guide comprising a first end and a further end, the light guide configured to guide light from the first end towards the further end from a light source located at or near the first end of the product display; and
one or more surface features respectively at one or more predetermined positions on a surface of the light guide for allowing a portion of light to exit the light guide at the one or more predetermined positions,
wherein the one or more surface features is a protrusion, indent, undulation or optical pattern.

2. A product display according to claim 1, further comprising at least two surface features at respective predetermined positions on the surface of the light guide for allowing a portion of light to exit the light guide at each respective predetermined position, wherein the at least two surface features are one or more of a protrusion, indent, undulation or optical pattern,
the light guide being configured to be connectable in use to a display panel, wherein one of the at least two surface features is positioned on the surface of the light guide to allow a portion of light to exit the light guide and illuminate the display panel.

3. A product display according to claim 1, further comprising:
at least two surface features at respective predetermined positions on the surface of the light guide for allowing a portion of light to exit the light guide at each respective predetermined position, wherein the at least two surface features are one or more of a protrusion, indent, undulation or optical pattern; and
a front shelf portion comprising a body portion and a display panel connectable to the body portion,
wherein a portion of the light guide extending between the body portion and the display panel includes one of the at least two surface features to allow a portion of light to exit the light guide and illuminate the display panel.

4. A product display according to claim 1, wherein the product display is a retail product display.

5. A product display according claim 1, wherein the light guide comprises a transparent, substantially transparent, semi-opaque or tinted panel.

6. A product display according to claim 1, wherein the light guide is formed from an optical grade clear material.

7. A product display according to claim 1, wherein the light is guided towards the further end of the light guide by internal reflection.

8. A product display according to claim 7, where the light guide is configured for total internal reflection of light incident at an angle greater than a critical angle of the light guide.

9. A product display according to claim 7, wherein the light guide is configured for total internal reflection of light incident at an angle of between 20 and 90 degrees.

10. A product display according to claim 1, wherein the product display further comprises one or more further light guides positioned in proximity to the one or more surface features, for guiding light exiting the one or more surface features.

11. A product display according to claim 1, wherein the one or more surface features is an optical pattern, and wherein the optical pattern is an optically patterned area configured to alter an angle of incidence of light at the surface such that at least a portion of light can exit the light guide at the optically patterned area.

12. A product display according to claim 1, further comprising a shelf or platform.

13. A product display according to claim 12, wherein the shelf or platform is releasably attachable to the light guide.

14. A product display according to claim 12, further comprising a front shelf portion comprising a body portion and a connecting element for releasably attaching the body portion to a front of the shelf or platform.

15. A product display according to claim 14, wherein the front shelf portion further comprises a display panel connectable to the body portion.

16. A product display according to claim 15, wherein at least a portion of the light guide extends between the body portion and the display panel.

17. A product display according to claim 15, wherein a surface of the portion of the light guide extending between the body portion and the display panel comprises an optically patterned area configured to alter an angle of incidence of light at the surface such that at least a portion of light can exit the light guide at the optically patterned area and illuminate the display panel.

18. A product display according to claim 17, further comprising a reflective panel between the body portion of the front shelf portion and the optically patterned area of the light guide for reflecting light towards to the display panel.

19. A product display according to claim 1, further comprising at least one light source positioned at or near a rear of a shelf platform to direct light into a rear end of the light guide.

20. A product display according to claim 1, further comprising a display panel selectively connected to the light guide, the display panel including an electronic or digital display screen positioned so as to be illuminated by a portion of light exiting the light guide.

21. (canceled)

22. A product display apparatus comprising:
a product display according to claim 1;
at least two slotted channels; and
at least two shelf brackets configured to support the product display and engage with slots in the slotted channels.

23. (canceled)
